(19) United States
(12) Patent Application Publication
(10) Pub. No.: US 2012/0068570 A1
(43) Pub. Date: Mar. 22, 2012

(54) PARALLEL PATH PHASE LEAD EXITS FROM ELECTRIC MACHINE

(75) Inventors: Brad Chamberlin, Pendleton, IN (US); David A. Fulton, Anderson, IN (US)

(73) Assignee: REMY TECHNOLOGIES, L.L.C., Pendleton, IN (US)

(21) Appl. No.: 12/885,751

(22) Filed: Sep. 20, 2010

(51) Int. Cl. H02K 3/28

(52) U.S. Cl. 310/198

(57) ABSTRACT

A stator winding for an electric machine includes two or more conductors defining one or more phases about the stator winding. Each phase includes at least two conductors of the two or more conductors arranged in an electrically switchable relationship. An end of each conductor of the two or more conductors extends to an exterior of the electric machine and is configured for independent electrical connection to a component at the exterior of the electric machine. An electric machine includes a stator having a stator winding including two or more conductors defining one or more phases about the stator winding including at least two conductors of the two or more conductors arranged in an electrically switchable relationship. An end of each conductor of the two or more conductors extends to an exterior of the electric machine for independent electrical connection to a component at the exterior of the electric machine.

### BACKGROUND OF THE INVENTION

The subject matter disclosed herein generally relates to electric machines. More specifically, the subject disclosure relates to phase lead connections for parallel path electric machines.

A wide array of devices now relies on electric machines for power. Electric powered transportation and hybrid electric machines are currently becoming more common as viable alternatives to fossil fuel powered vehicles. As electric powered vehicles grow in popularity, there is a need to enhance electric machine output efficiency.

A stator of a typical electric machine includes a stator winding which is wound in series or wound with a defined number of phases. The wiring harness which connects the electric machine to, for example, an inverter, typically provides one connector per phase, regardless of the number of paths, such as parallel paths in each phase. The paths are typically connected to each other inside of the machine, so that one connection per phase is then provided outside of the machine for the wiring harness. One connector per phase limits the possible connection schemes between the electric machine and the inverter, thus potentially limiting the efficiency and/or output of the electric machine.

### SUMMARY

Disclosed is a stator winding for an electric machine including two or more conductors defining one or more phases about the stator winding. Each phase includes at least two conductors of the two or more conductors arranged in an electrically switchable relationship. An end of each conductor of the two or more conductors extends to an exterior of the electric machine and is configured for independent electrical connection to a component at the exterior of the electric machine.

Also disclosed is an electric machine including a rotor located at a central axis and a stator located relative to the rotor. The stator includes a stator core and a stator winding having two or more conductors defining one or more phases about the stator winding. Each phase includes at least two conductors of the two or more conductors arranged in an electrically switchable relationship. An end of each conductor of the two or more conductors extends to an exterior of the electric machine and is configured for independent electrical connection to a component at the exterior of the electric machine.

### BRIEF DESCRIPTION OF THE DRAWINGS

Referring now to the drawings wherein like elements are numbered alike in the several Figures:

FIG. 1 is a cross-sectional view of an embodiment of an electric machine; and

FIG. 2 is a schematic view of an embodiment of a conductor arrangement for an electric machine.

### DETAILED DESCRIPTION

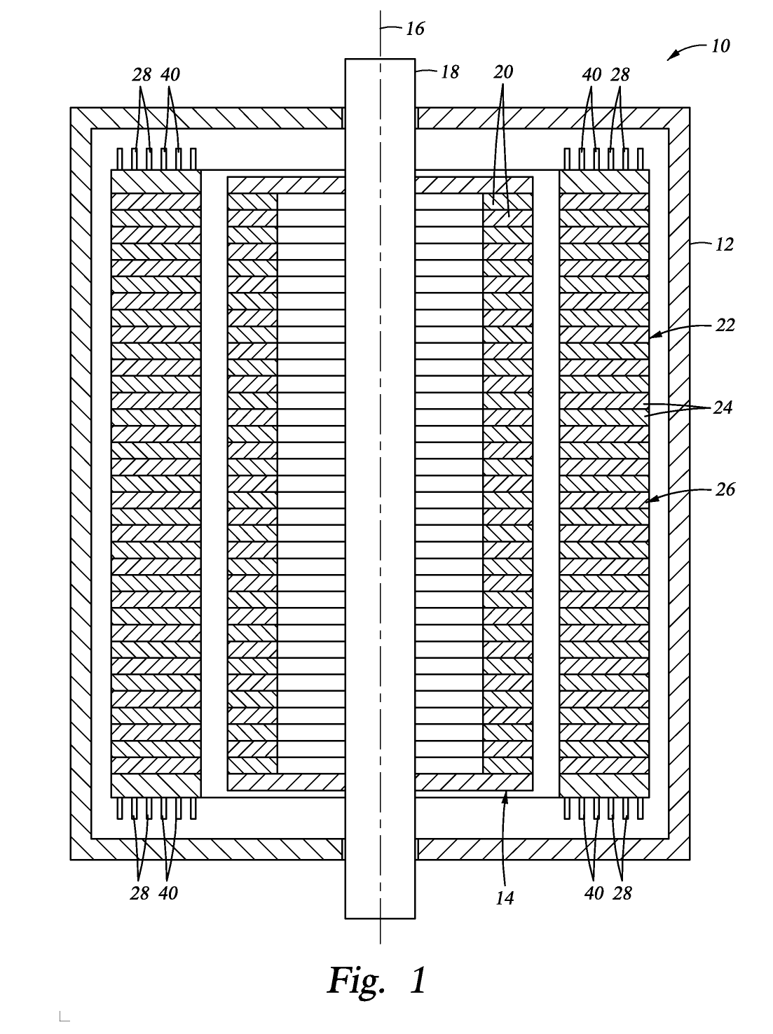

Shown in FIG. 1 is a cross-sectional view of an embodiment of an electric machine 10, for example, an alternator or generator. The electric machine 10 includes a housing 12 with a rotor 14 rotatably located in the housing 12 at a central axis 16 of the electric machine 10. The rotor 14 comprises a rotor shaft 18 and, in some embodiments, a plurality of rotor laminations 20 affixed to an outboard surface of the rotor shaft 18. A stator 22 is disposed radially outboard of the rotor 14. The stator 22 extends axially along a length of the rotor 14 and substantially circumferentially surrounds the rotor 14. The stator 22 includes a plurality of stator laminations 24 which in some embodiments are arranged substantially axially to form a stator core 26. A plurality of conductors 28 extend through the stator core 26 to form a plurality of stator windings 40.

Each winding of the plurality of stator windings 40 extends independently from the stator 22 and is connected to a wiring harness 32 which is, in turn, connected to an external component such as an inverter 34. In some embodiments, the external component includes a plurality of switching elements 42, one for each stator winding 40 and connected thereto. Use of the switching elements 42 allows for the stator windings 40 to be selectively energized and to be connected in a variety of electrical connection configurations, such as a series configuration, a parallel configuration, a wye configuration, a delta configuration, or combinations thereof.

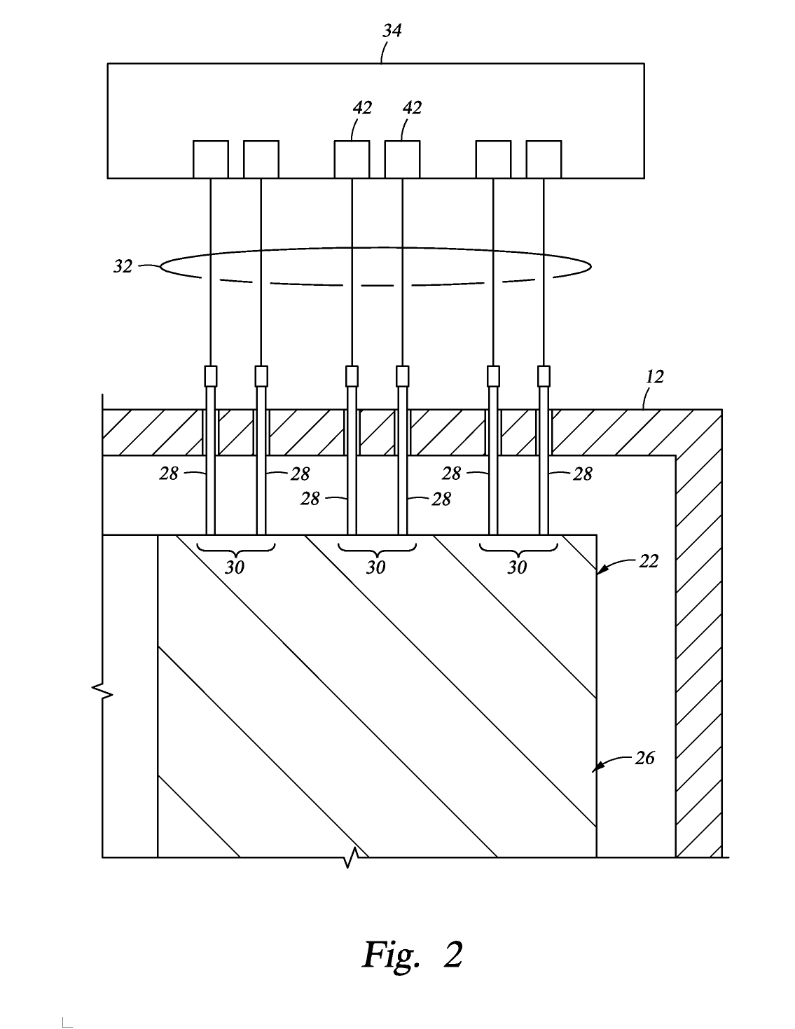

Referring to FIG. 2, in one embodiment of the electric machine 10 the stator windings 40 are arranged in three phases 30, with each phase 30 having two conductors 28. Each conductor 28 extends independently through the housing 12 to an exterior of the electric machine 10 where it is connected to the wiring harness 32 which is, in turn, connected to an external component such as the inverter 34. Further, the conductors 28 routed through the housing may include phase leads, jumpers, cross-overs, neutrals, or other like conductors.

Routing of each conductor 28 independently to the inverter 34, rather than one conductor 28 per phase 30 as in the prior art, allows for utilizing the switching elements 42 to turn off and on current to one or more conductors 28 of each phase 30, to deenergize and energize each conductor 28 independently. The energizing and deenergizing of individual conductors 28 effectively increases or decreases a number of stator turns in the electric machine 10 as desired during operation of the electric machine 10. The capability of varying the number of stator turns has several advantages including better utilization of available voltage, reduction of current levels through the conductors 28, and increased efficiency of the electric machine 10. Further, the independent routing and connecting of the conductors 28 to the inverter 34 allows for changes in the electrical connection configuration of the conductors 28 and stator windings 40 between series, parallel, wye, delta, and other connection configurations to improve efficiency in operation of the electric machine 10.

While one or more embodiments have been shown and described, modifications and substitutions may be made thereto without departing from the spirit and scope of the invention. Accordingly, it is to be understood that the present invention has been described by way of illustrations and not limitation.

1. A stator winding for an electric machine comprising:
two or more conductors defining one or more phases about the stator winding, each phase including at least two conductors of the two or more conductors arranged in an electrically switchable relationship, an end of each conductor of the two or more conductors extending to an exterior of the electric machine and configured for independent electrical connection to a component at the exterior of the electric machine.

2. The stator winding of claim 1, wherein each conductor of the two or more conductors are configured such that each conductor may be individually energized and/or deenergized.

3. The stator winding of claim 2, wherein the energizing and/or deenergizing of individual conductors of the at least two conductors increases or reduces a number of effective stator turns in the stator winding.

4. The stator winding of claim 1, wherein the two or more conductors comprise three phases.

5. The stator winding of claim 1, wherein each phase includes two conductors of the two or more conductors arranged in the electrically switchable relationship.

6. The stator winding of claim 1, wherein each conductor of the two or more conductors extends independently from the stator winding through a housing of the electrical machine.

7. The stator winding of claim 1, wherein the component is an inverter.

8. An electric machine comprising:
a rotor disposed at a central axis; and
a stator disposed at the rotor including:
a stator core; and
a stator winding including:
two or more conductors defining one or more phases about the stator winding, each phase including at least two conductors of the two or more conductors arranged in an electrically switchable relationship, an end of each conductor of the two or more conductors extending to an exterior of the electric machine and configured for independent electrical connection to a component at the exterior of the electric machine.

9. The electric machine of claim 8, wherein each conductor of the two or more conductors are configured such that each conductor may be individually energized and/or deenergized.

10. The electric machine of claim 9, wherein the energizing and/or deenergizing of individual conductors of the at least two conductors increases or reduces a number of effective stator turns in the stator winding.

11. The electric machine of claim 8, wherein the two or more conductors comprise three phases.

12. The electric machine of claim 7, wherein each phase includes two conductors of the two or more conductors arranged in the electrically switchable relationship.

13. The electric machine of claim 8, wherein the component is an inverter.

14. The electric machine of claim 8, wherein each conductor of the two or more conductors extends independently from the stator winding through a housing of the electrical machine.
